(19) United States
(12) Patent Application Publication
(10) Pub. No.: US 2005/0091102 A1
(43) Pub. Date: Apr. 28, 2005

(54) A METHOD AND SYSTEM FOR MANUFACTURING FACILITY PERFORMANCE INDICATOR BENCHMARKING

(76) Inventor: Theodora Retsina, Atlanta, GA (US)

Correspondence Address: American Process Inc;Steve Rutherford, 56 17th Street N.E., Atlanta, GA, 30309, US

(21) Appl. No.: 10/904,114

(22) Filed: Oct. 25, 2004

Related U.S. Application Data
(60) Provisional application No. 60/513,878, filed on Oct. 24, 2003.

(51) Int. Cl. G06F 17/60

(52) U.S. Cl. 705/10

(57) ABSTRACT

A web-based Performance Indicator Benchmarking software application for standardized performance reporting and benchmarking of manufacturing facilities. This is achieved by having common definitions and calculations for measuring performance, a database of actual values for performance measurements from a large number of similar facilities, and the ability to filter results based on facility specific attributes such as location, process configuration, products, etc. The application database updates dynamically so that users can effectively manage performance on the basis of current information.

### FIELD OF THE INVENTION

This invention relates, in general, to the benchmarking of manufacturing facilities, and more particularly, to the meaningful reporting and comparison of the performance of the manufacturing facilities.

### BACKGROUND OF THE INVENTION

Most manufacturers do not have standard ways to measure the performance of their facilities or various departments even in manufacturing facilities of common ownership. The differences may include boundary definitions, choice of performance indicator, units of measurement, time scale reference rules for data screening and others. Moreover many of the facility and organization performance reports are not updated regularly and when this is done it is very labor intensive.

Whenever performance measurement standardization does exist it typically does not account for the different configurations that may be present for specific departments. Such deficiencies make it difficult to meaningfully compare and benchmark the performance of different facilities within the same business sector.

Furthermore, comparison between data for ranking and benchmarking purposes is often done without attention to the time reference the data was obtained. An example in the energy field is comparing manufacturing facilities in very different climatic conditions, or comparing average data from one facility with peak performance data from the other.

Benchmarking is a process by which the performance of a facility is compared with the numbers that are accepted to represent average, or best performance of competing facilities. Often these numbers are obtained from literature and may or may not be representative of a statistically significant sample. As these numbers are obtained from literature, almost always, they are aged and do not represent current performance. This compounded with the other possible inconsistencies listed above, i.e., boundary definition, units, time reference and data rules, make this comparison uncertain and in some cases simply not meaningful.

Manufacturing facilities that make more than one product do not have a consistent way of apportioning the variable costs, such as energy and raw materials, or the fixed costs, such as labor between the different products, or deriving meaningful performance targets for the mixed production facility.

Classical reporting solutions use only historical data and are typically published a considerable time after the data collection.

Accordingly a need exists for a more convenient, timely and standardized reporting and benchmarking of manufacturing facilities.

### SUMMARY OF THE INVENTION

The invention presented herein, Performance Indicator Benchmarking (PIB), is an automatically updating, world wide web based software application that provides manufacturing facilities with a convenient, real-time standardized system for reporting performance, for benchmarking, and comparing its performance against a statistically meaningful data set.

### BRIEF DESCRIPTION OF THE DRAWING

A more complete understanding of the present invention may be obtained by reference to the following Detailed Description when read in conjunction with the accompanying Drawings wherein:

FIG. 1 is a block diagram of the hierarchy to represent a manufacturing facility in PIB

FIG. 2 illustrates a product furnish matrix

FIG. 3 illustrates a sample of a PIB benchmarking report

FIG. 4 illustrates a typical PIB ranking plot

FIG. 5 illustrates examples of matrices to calculate KPI target values

FIG. 6 illustrates an overview of the PIB system architecture

FIG. 7 is a block diagram illustrating how data is uploaded into PIB using the MIS link interface

FIG. 8 illustrates PIB facility level attributes

FIG. 9 illustrates the user interface for PIB auto upload scheduler

FIG. 10 illustrates the filtering ranking plots in PIB

FIG. 11 illustrates the types of reports available in PIB

FIG. 12 illustrates pictorially the PIB subsystems

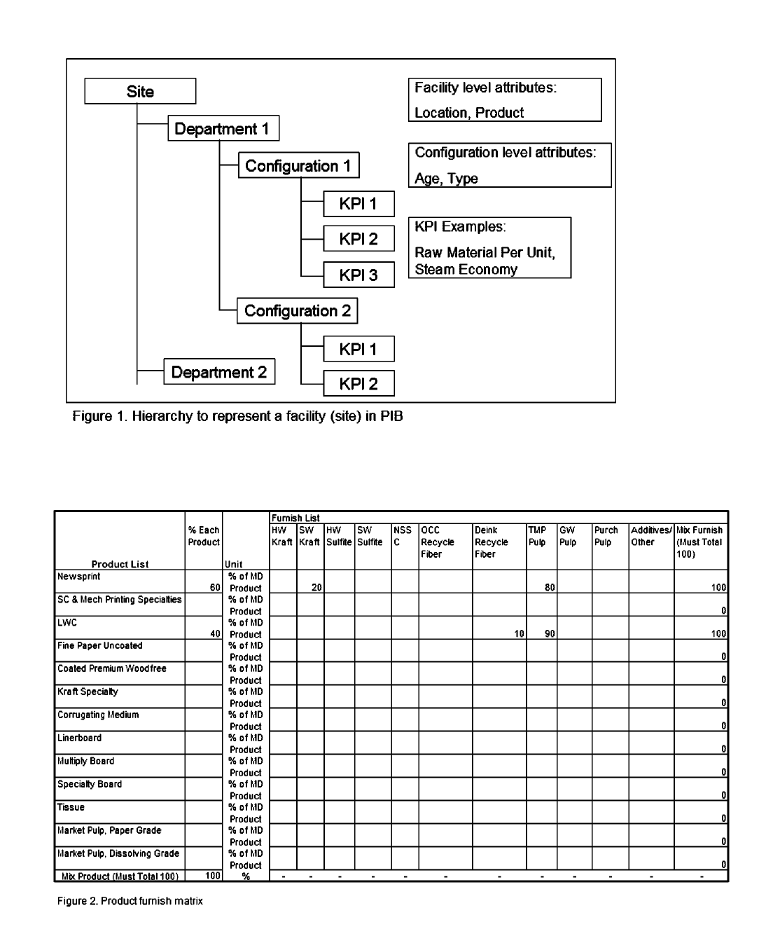

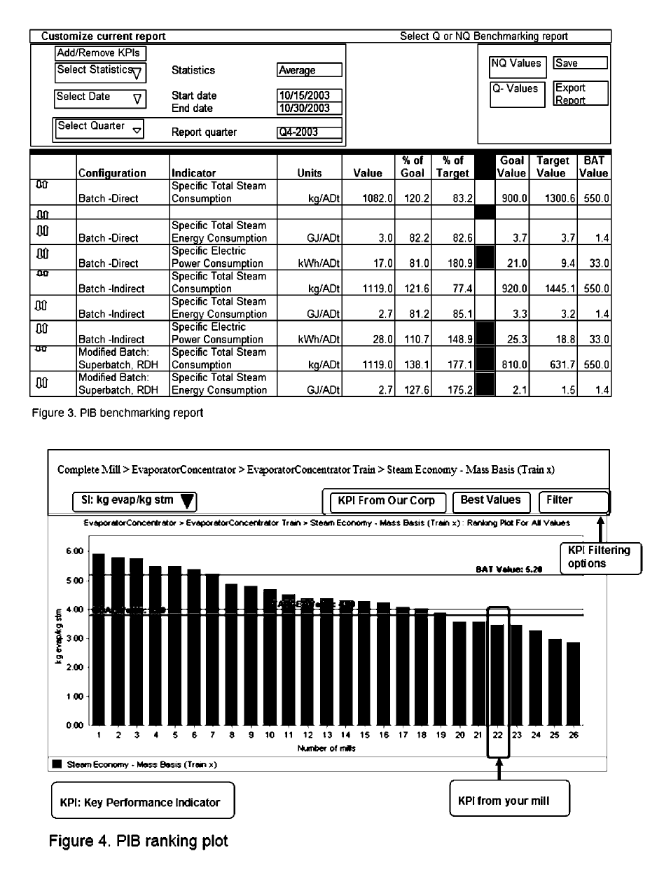

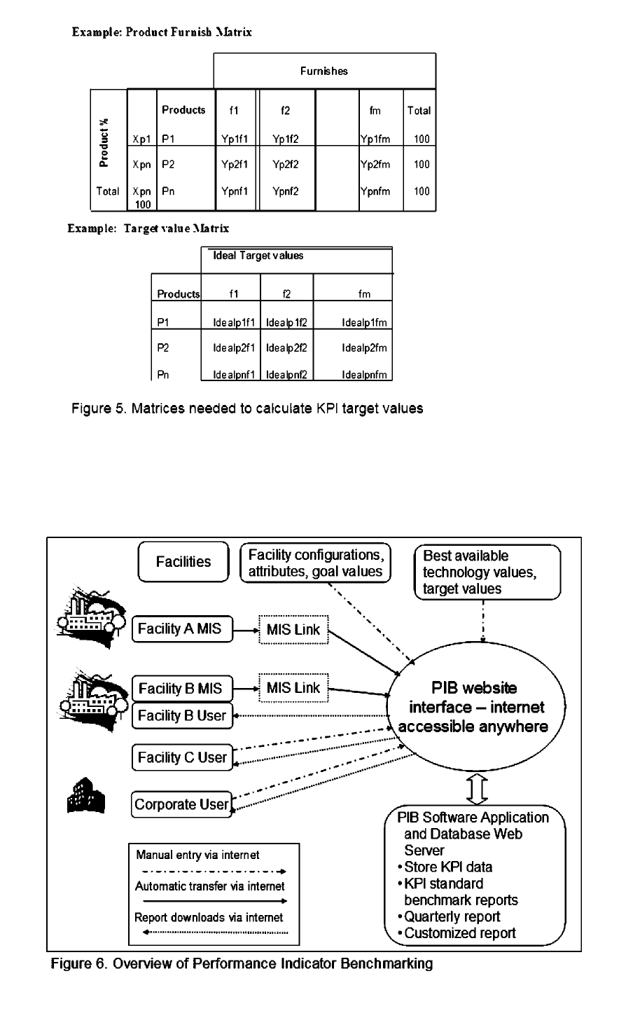

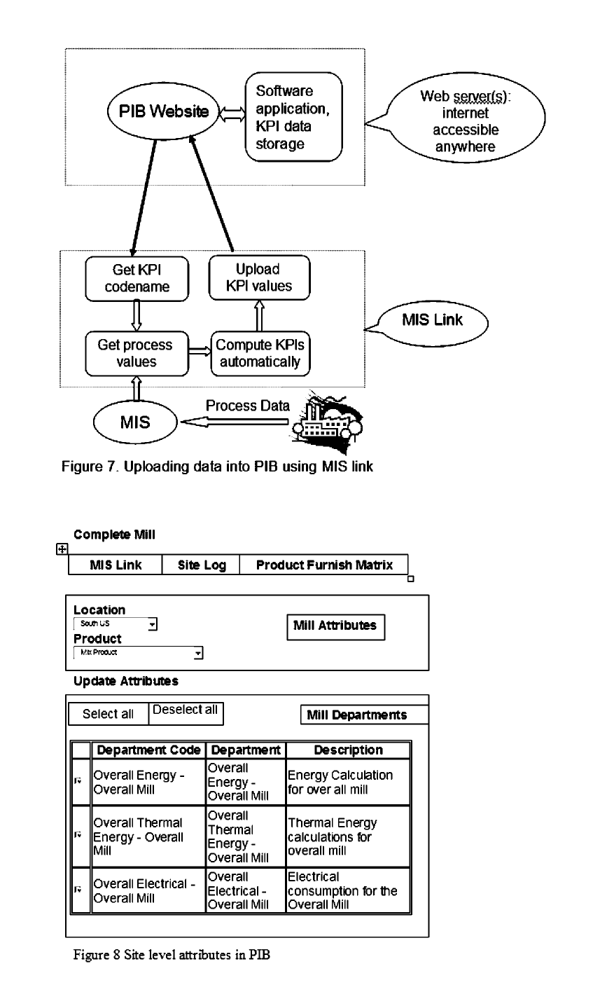

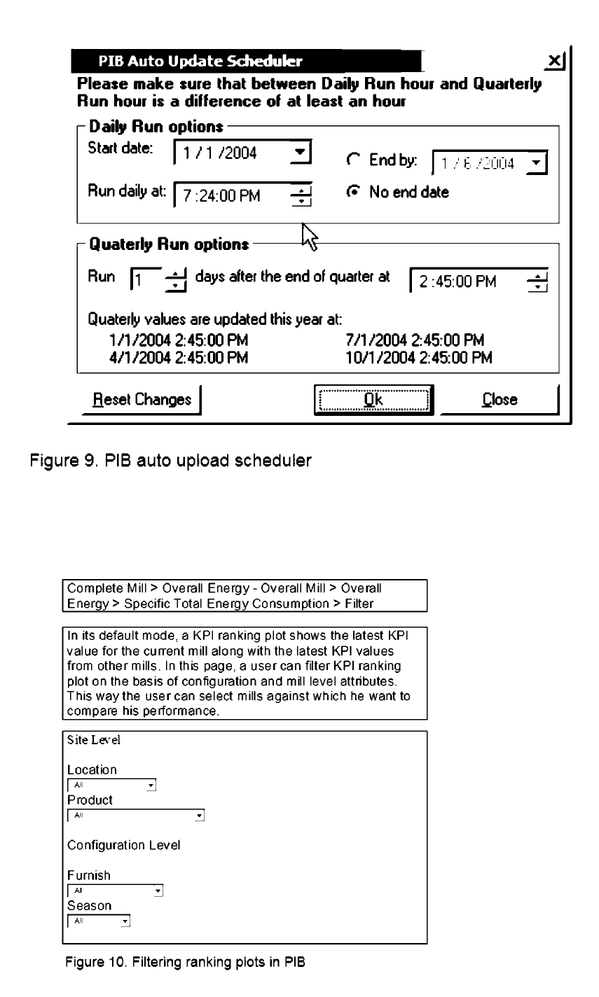

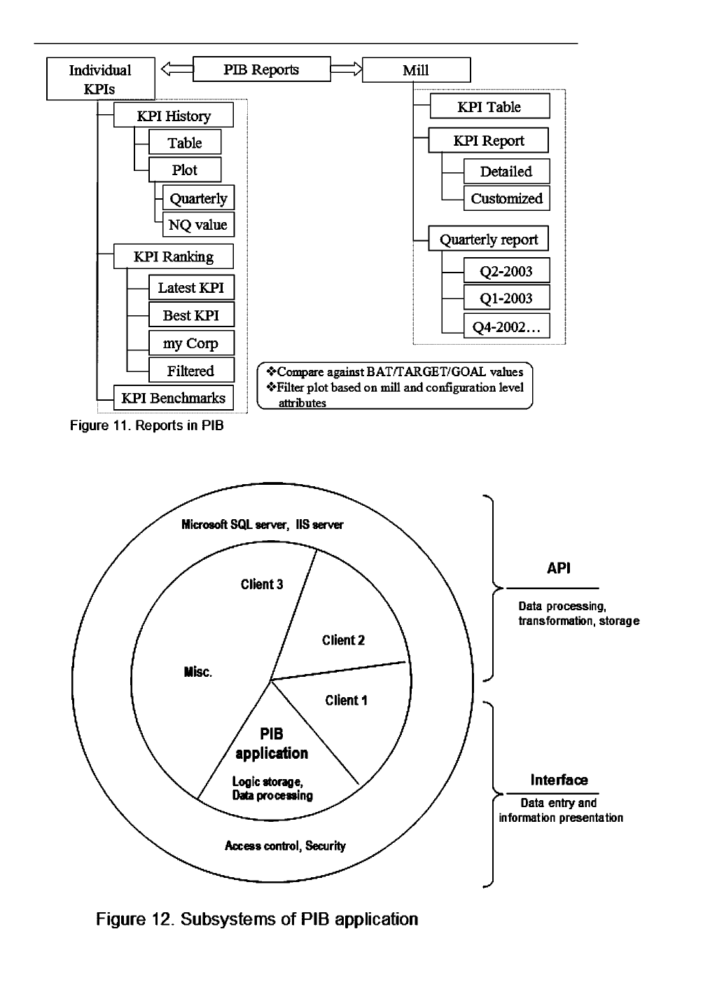

### DETAILED DESCRIPTION OF THE INVENTION

The invention PIB software application uses the following methodology:

KPIs: Standardization is achieved by calculating performance at facilities in terms of parameters called Key Performance Indicators (KPIs); a KPI is the basic unit of reporting and benchmarking information in PIB. KPIs are formulated for both the overall facility as well as for the individual departments within it.

Data validation: KPI values are formulated based on the actual operating data from the facility. A series of data checks are performed to prevent the upload of incorrect data, caused by malfunctioning instruments at the actual site, into the invention. In the preferred form of the invention, the checks include upper and lower limits for KPIs, as well as warning when a certain KPI value has changed in a statistically significant manner from its previous value.

Overall manufacturing facility—site: In the invention, the overall manufacturing facility or site, is defined as the boundary that closely represents the physical edifice but that is more clearly defined as the definition boundary within which the site receives, raw material, energy and labor.

Departments and configurations: In the invention, each facility is divided in departments; these departments have clearly set boundaries. For each department there are different configurations reflecting the choice of manufacturing technology.

Attributes: Furthermore, the concept of attributes has been assigned to the overall site as well as the configuration level. Attributes are parameters that enable comparison of KPIs with target values or KPIs in different facilities. This prioritization and clear definition of boundaries can be seen in the FIG. 13.

Furnish matrix: The invention sets a clear and unique way of understanding how performance should be measured and apportioned in manufacturing facilities that have more than one furnish materials and produce more than one product. This is accomplished with the “furnish matrix,” which is a key concept of the proposed invention, PIB. In its first preferred mode, the furnish matrix is a two dimensional matrix that has the furnish variety on one axis and the product variety on the other. In another preferred form of the invention, the furnish matrix is three dimensional, with time being the third axis, reflecting the fact that, the permutation of furnishes and products may vary with time. A representation of the two dimensional furnish matrix can be seen in FIG. 14.

Population data: In the invention, the KPIs from the participants are stored in a database for reporting and manipulation.

Target values: In the preferred form of the invention, the target values are defined as the average value of the best 25% of performers participating in the invention. The performers in this population data must have the same combination of department * configuration * attribute. In another form of the invention, when applicable, target values may be externally set.

BAT values: The acronym stands for Best Achievable Technology. In the preferred form on the invention, BAT values are selected from the population data to be the best performance at each department level, irrelevant of configurations and attributes. In another form of the invention, BAT values may also be derived from external (outside the population data) sources.

Goal value: This performance number is selected by each facility to represent the gap closure they desire to achieve between the actual KPI performance and the target value.

Once a facility is set up, and populated with department, configuration, and attributes, reporting of the performance of each department is achieved through the use of KPIs. Benchmarking of performance is achieved by comparison with Target and BAT values and by ranking in the population data. The ranking is achieved by graphically plotting data in a distribution diagram that clearly identifies the performance of said facility within its peers. This same analysis allows the facility to set itself a goal value. Error! Reference source not found. shows a benchmarking report while Error! Reference source not found. shows a ranking graph.

Facility-wide target values. While department's targets are clearly defined by sorting the population data base, in the preferred form of the invention another methodology is employed for setting targets for the overall facility KPIs. This is based on the concept of the furnish matrix and the target value matrix. The target matrix has target values for the ideal facilities. Ideal facilities are either an imaginary facility that produces only one product using just one furnish or the top 25% of the performers in the database that produce one product with one furnish, as necessary. Ideal facilities are useful constructs in determining target values for the real facilities.

Once this target value matrix is set up, overall targets for the facility are obtained by proportionally reflecting the facility combination of product and furnishes and apportioning to the facility the performance in proportion to their contributions, according to the equations below, using information from both the furnish and the target matrices.

### EXAMPLE

The facility in the following example uses m furnishes (f1, f2 . . . fm) to manufacture n products (p1, p2, p3 . . . pn); see Error! Reference source not found.. The target value, for this facility, is calculated using the following formulae:
Targetₒᵥₑᵣₐₗₗ=X_{P1}*Target_{P1}+
X_{P2}*Target_{P2}+X_{P3}*Target_{P3}+ . . . +X_{Pn}*Target_{Pn}
Targetₚ₁=Y_{p1f1}*Ideal_{p1f1}+Y_{p1f2}*Ideal_{p1f2}+ . . . +Y_{p1fm}*Ideal_{p1fm}
Targetₚₖ=Y_{pkf1}*Ideal_{pkf1}+Y_{pkf2}*Ideal_{pkf2}+ . . . +Y_{pkfm}*Ideal_{pkfm}
   Where,
Targetₒᵥₑᵣₐₗₗ=Target value for an overall KPI for a real facility
Xₚₙ=fraction of real facility's total production that is product 1
Xₚₙ=fraction of real facility's total production that is product n
Targetₚ₁=Portion of Overall Target value attributed to product 1
Targetₚₙ=Portion of Overall Target value attributed to product n
Y_{p1f1}=Fraction of furnish f1 used to make product p1
Y_{p1fm}=Fraction of furnish fm used to make product p1
Ideal_{p1f1}=Target value of an ideal facility that only makes product 1 using only furnish f1

Allocation of performance per product line: Many facilities produce a variety of products. For such facilities, Overall KPI values are apportioned into product specific portions in the preferred form of the invention. The apportioning is important for analyzing the performance of each product and for comparing performances when manufacturing products at different facilities. The actual KPI values are stored in the invention. These actual values are split into product specific portions using two information pieces: product furnish matrix and target value matrix. The product specific portions are calculated using the following formula:
KPIₚₖ=KPI_{Actual}*(Targetₚₖ)/Targetₒᵥₑᵣₐₗₗ
Targetₒᵥₑᵣₐₗₗ=X_{P1}*Target_{P1}+
X_{P2}*Target_{P2}+X_{P3}*Target_{P3}+ . . . +X_{Pn}*Target_{Pn}
Targetₚₖ=Y_{pkf1}*Ideal_{pkf1}+Y_{pkf2}*Ideal_{pkf2}+ . . . +Y_{pkfm}*Ideal_{pkfm}
   Where,
KPI_{Actual}=Actual value of the KPI
KPIₚₖ=Portion of actual KPI value that is apportioned to the product k
Targetₒᵥₑᵣₐₗₗ=Target value for an overall KPI for a real facility
Targetₚₖ=Portion of Overall Target value that is attributed to product k
Xₚ₁=fraction of real facility's total production that is product 1
Xₚₙ=fraction of real facility's total production that is product n
Y_{p1f1}=Fraction of furnish f1 used to make product p1
Y_{p1fm}=Fraction of furnish fm used to make product p1
Ideal_{p1f1}=Target value of an ideal facility that only makes product 1 using only furnish f1

The invention, PIB software application is located on a web-based server computer. The PIB website, also located on the same server, provides an interface for linking and interacting with the invention. The PIB website can only be accessed by an authorized user but this can be from any computer or a device with internet browsing capability, see Error! Reference source not found.

Each authorized user must be assigned a login name and password for the PIB website. For enhanced security and verification, the invention also incorporates hardware or software identification. Access rights per facility and privilege levels within PIB can be set for each user by an authorized administrator.

Referring to Error! Reference source not found. the preferred form of the invention requires the use of a central computer which stores all data and communicates such data to multiple users through usage of web pages in the World Wide Web. Each user communicates to the presented data through connection from the user's computer to the appropriate page in the World Wide Web. A series of networks privileges assignation allows each user different set of information review form those contained in the central computer. For example a user can see its ranking in performance in a set of its peers but cannot see the identification of the other members of the comparison group.

PIB software application has three main components:

1. Configuration component:

The configuration component provides an infrastructure for the user to model facilities in PIB by selecting from pre-assigned menus. Facilities are modeled in a hierarchical fashion, as shown in the Error! Reference source not found. Departments are at the top level representing the major functional areas of a facility, for example in a paper mill the pre-assigned menu will include pulping, bleaching, paper machine, and recovery plant. Each of these departments has one or more configurations which form the second level in the facility hierarchy. Again using the paper mill example, the batch cooking department will have an additional pre-assigned menu with three configuration options: batch-direct, batch-indirect, modified batch. At the base level of the hierarchy, each configuration option has at least one KPI. Once again in the paper mill example, specific thermal energy consumption is an example of a KPI. The KPIs provide the standardization for reporting and benchmarking and can be user selectable from a pre-assigned menu. To complete the facility model the user enters attributes at the site level, such as product(s) and location, and at the configuration levels, e.g., age, as shown in the Error! Reference source not found..

2. Calculation of KPIs and data upload component:

In the present form of invention there are three ways of calculating KPIs:
(1)A user manually calculates KPI values in accordance with the pre-defined algorithms outside the PIB application and then enters these into PIB manually, by typing them in an electronic keyboard.
(2) A user manually enters the values of the specified performance data points needed to calculate the KPIs into PIB. PIB then automatically computes the KPI values based on the customized algorithms embedded in the application.
(3) Customized algorithms embedded in PIB compute the KPIs from user specified data points. These points are automatically uploaded from the facility Management Information System (MIS) or other electronic data archive system using the MIS Link interface, as shown in the Error! Reference source not found..

The MIS Link interface takes its name from the acronym of Management Information System (MIS) which most manufacturing facilities have available and which records data about processes and usages of all furnish and energy necessary in the facility's manufacturing process. The MIS Link interface is therefore linked with the MIS system and allows downloading of the appropriate data numerically manipulated in different chosen ways, i.e., average, best or excluding extreme data.

Once a facility is set up, as described above, a MIS Link file is automatically generated. In essence, this file is a custom configured subset of all the KPIs that the user has selected out of the complete set of KPIs that are available in the database of PIB.

The MIS link file lists the data that a facility must provide to enable automatic calculation of the KPIs so that they can be uploaded to the web site.

In the preferred form of the invention, once the user has chosen the automatic data entry via the MIS link file, an update routine is also included. This routine downloads on the user's computer and automatically updates values of the calculated KPIs to the central database and the website at predetermined timely intervals as can be seen in the Error! Reference source not found..

KPI values are date-time stamped and stored in PIB's relational data base. Logic within PIB identifies out-of-range or erroneous values and flags these to the user through the PIB website pages.

3. Benchmarking component:

The benchmarking component allows benchmarking of facility KPIs and reporting in a number of user selectable table, chart and report formats. The user can also generate and save customized KPI reports. Benchmarking features allow actual facility KPIs to be compared to facility history, facility goals, facility targets, other facilities, and best available technology over a user selectable time period. User selectable filters are provided to benchmark at the departmental or total facility level, by location, product type, etc. as shown in the Error! Reference source not found.. A variety of reports, as shown in the Error! Reference source not found. can be generated on a video screen or in paper.

Best available technology KPIs are at the department level since these are the best achieved with any department configuration, while target KPIs are at the configuration level since these are the best achieved for that specific department configuration. All KPIs are from actual facility performance data. In the preferred form of the invention, all target and BAT values are selected form the PIB population data base, as explained above. In another form target and BAT values are manually entered by the PIB host administrators from various trade journals, technical reports, surveys, conference proceedings, research papers, manufacturer information, studies, etc. Goal values are entered manually by the user.

For example, a target is the best achieved for that specific department configuration, whereas best available technology is the best achieved with all possible configurations for that department; to illustrate this difference, the target could be the top speed of a Ford sedan and best available technology would be the top speed from any production line sedan automobile.

The application consists of three main subsystems, i.e., interface for data entry, data processing, and information presentation as illustrated in Error! Reference source not found.. These subsystems enable the PIB software application to perform the following functions:

Configuration: Set up a new facility from pre-configured departments, configurations, and KPIs

Analysis and Reporting: Analyze and report KPIs in various graphical formats

Data and logic storage: Store KPI definitions, BAT, TARGET, and GOAL values for KPIs as well as KPI data from industry sources, studies, client facilities

The invention benchmarking parameters will have many manifestations, including labor, raw materials, energy, unit costs, etc. In these manifestations this software application is customized to cover any cost input variable to any manufacturing facility.

Although other modifications and changes may be suggested by those skilled in the art, it is the intention of the inventors to embody within the patent warranted hereon all changes and modifications as reasonably and properly come within the scope of their contribution to the art.

1. A method for accurately, conveniently, quickly, and meaningfully reporting, comparing and benchmarking the performance of manufacturing facilities comprising:
utilizing a world wide web-based Performance Indicator Benchmarking (PIB) software application and computerized system to perform the following steps:
configure a model of a manufacturing facility (facility) in terms of its major process departments; and
configure each of the major process departments in terms of their major process equipment; and
assign one or more Key Performance Indicators (KPIs) per department; and
enter attributes for the facility, such as product(s) and location, equipment age, etc.; and
create a data transfer interface between the world wide web based PIB software application and the facility's Management Information System (MIS); and
calculate the KPIs from the facility's data; and
store the results of the calculated KPIs; and
report, compare, and benchmark the manufacturing facility's performance as measured by its KPIs.

2. A method according to claim 1, further comprising the steps of:
provision of an infrastructure for the user to model facilities in PIB by selecting major process departments from pre-assigned menus; and
provision an infrastructure for the user to model departments in PIB by selecting major process equipment from pre-assigned menus; and
provision an infrastructure for the user to select KPIs for each major process equipment from pre-assigned menus.

3. A method according to claim 1, further comprising the step of:
provision of automatic generation of the MIS Link file from the facility model configured in PIB.

4. A method according to claim 1, further comprising the step of:
provision of pre-checked KPI calculation algorithms embedded in PIB to ensure standardized comparison and benchmarking between facilities.

5. A method according to claim 1, further comprising the step of:
provision of automatic data entry via the MIS link file, including an update routine that downloads on the user's computer, computes the KPI algorithms from user specified data points, and automatically uploads the values of the calculated KPIs to the PIB website at user determined time intervals.

6. A method according to claim 1, further comprising the steps of:
date-time stamping uploaded KPI values to PIB and storing these in PIB's relational data base on a world wide web server; and
provision of logic within PIB to identify out-of-range or erroneous KPI values and flag these to the user through the PIB website pages.

7. A method according to claim 1, further comprising the steps of:
provision of a benchmarking component with PIB that allows benchmarking of facility KPIs and reporting in a number of user selectable table, chart and report formats; and
provision for the user to generate and save customized KPI reports; and
provision of features to allow actual facility KPIs to be compared to facility history, facility goals, facility targets, other facilities, and best available technology (BAT) over a user selectable time period; and
provision of user selectable filters to benchmark at the departmental or total facility level, by location, product type, etc.; and
provision of benchmarking using the facility's real time data to ensure performance comparison and benchmarking is done with up to date data from a statistically significant data body.

8. A method according to claim 1, further comprising the steps of:
provision of self generated target and BAT values from the PIB database; and
provision for calculating overall site target in complex manufacturing facilities that use more than one furnish to produce more than one product.

9. A method according to claim 1, further comprising the step of:
provision for apportioning performance numbers in a complex manufacturing facility to each of the products produced therein.

10. A method according to claim 1, further comprising the steps of:
provision to allow users to access the information and observe performance of the manufacturing facility, benchmark the facility performance against target and BAT values and rank the performance of the facility at any given time from any place where the user has access to the world wide web; and
provision of outputting information of performance or benchmarking in a video terminal or in a paper form.
